(19) United States
(12) Patent Application Publication
(10) Pub. No.: US 2005/0029773 A1
(43) Pub. Date: Feb. 10, 2005

(54) X-Tender

(76) Inventors: Wayne Day, Cullman, AL (US); Brent C. Cupp, Cullman, AL (US)

Correspondence Address: Frank Williams, Jr., 207 2nd Ave. S. E., Cullman, AL, 35055, US

(21) Appl. No.: 10/637,016

(22) Filed: Aug. 8, 2003

(51) Int. Cl. B62K 25/12

(52) U.S. Cl. 280/284

(57) ABSTRACT

A steel stock machined on a lathe, turned and milled and mounted between the rod of the mono-shock and the mounting eyelet in the rear suspension mechanism of a Yamaha motorcycle. The shock extends the length of the rear shock and raises the rear bike fender height for increased performance of the motor bikes rear shock mechanism, creating a smother ride in the bike.

### CROSS REFERENCE TO RELATED APPLICATIONS

### STATEMENT REGARDING FEDERALLY SPONSERED RESEARCH OR DEVELOPMENT

Not Applicable

### BACKGROUND OF THE INVENTION

The inventors, Brent C. Cupp and Wayne Day, while attending a motocross at a local Track noticed how one particular bike was being ridden. The seat height, that is, the distance from the seat to the ground and the distance from the rear fender to the tire was extremely low and the low distance caused the motor bike to “bottom-out” over jumps and in some cases the muffler bracket would break due to the pressure exerted an the suspension system during a jump. After a closer look at the rear suspension mechanism on the bike and careful planning, the inventors created the “X-Tender” a unique device when applied to the suspension mechanism of the bike raised the seat height approximately four (4) inches further from the ground and also raised the rear fender and muffler four (4) inches further from the rear tire.

### BRIEF SUMMARY OF THE INVENTION

The idea of the “X-Tender” originated, was sketched, and created by the inventors jointly and in concert with each other. The purpose or need for the invention and an application of the device may vary from rider to rider. The effect to the bike, however, is the same, the height or distance between the seat and the ground is increased by four (4) inches. Also the distance between the rear fender and muffler and the rear tire is increased by four (4) inches.

The actual and visible increase in seat height by use of the “X-Tender” would serve or accommodate a rider who purchased Yamaha PW 80 1983-present or TTR 90 Yamaha 1999 but who may have outgrown the bike over time. A young rider usually out grows the bike before the useful life of the bike has expired. The “X-Tender” raises the seat four (4) inches higher then the original design to accommodate or adjust to the rider's increase in leg length due to natural growth of the rider.

The result of the application of the “X-Tender” to the suspension system of a Yamaha PW 80 1983-present or TTR 90 Yamaha 1999 would simply increase or lengthen the leg distance for a bike owner or rider and provide the owner or rider a longer, useful and more comfortable bike to ride during the natural human growth process of the owner or rider.

Another application purpose use, or need of the “X-Tender” as to accommodate a rider who rides or participates in motocross racing. In motocross racing the bike's suspension systems is pushed to its limit due to the ramping, jumping, and many lifts the bike is required to make. This ramping or jumping causes what riders refer to as the “bottom-out” effect or feeling. This occurs when a bike and rider spans a lift or ramp on the track and touches down causing the bike's suspension mechanism to contract at the moment of impact. By providing four (4) extra inches to the suspension mechanism the “X-Tender” will prevent the bike rear fender and muffler from making contact with the rear tire (in other words, preventing the “bottom-out” effect or feeling.)

The “X-Tender” design is a simple 1215 steel stock three-fourths (¾) inches in diameter and 2.125 inches long machined on a C N C lathe turned and milled. The finished product is covered with a zinc chromate finish. The device is mounted between the rod of the mono-shock and the mounting eye let in the suspension mechanism of the bike with simple or common hand tools.

This application extends the length of the shock thus raising the rear bike fender height. “X-Tender” has been machined and field tested with absolutely no problems with either the assembly or use. Once tested the X-Tender greatly reduced the “bottom-out” effect at moment of touchdown. Once the “X-Tender” was added to the suspension mechanism maximum performance of the bike was obtained, the bike handled exceptionally better with a smoother ride.

### BREIF DESCRIPTION OF THE SEVERAL VIEWS OF THE DRAWINGS

FIG. or photograph 1 (one) is a digital photograph of a Yamaha motor dirt bike before the “X-Tender” has been installed. Please note this distance of the seat to the ground and the rear fender and muffler to the rear tire.

FIG. or photograph 2 (two) is a computer enhanced photograph of the same motor dirt bike after the “X-Tender” has been installed. Please note the distance of the bike seat to the ground and the rear fender and muffler to the rear tire.

From the photograph, visibly the distance from the seat to the ground has increased by four (4) inches. Also the distance between the rear fender and the muffler bracket has increased four (4) inches.

FIG. 3 (three) depicts the entire suspension mechanism or assembly of the 80 Yamaha Dirt bike. The drawing is provided so that the viewer can see the entire suspension mechanism and how the “X-Tender” is easily installed. The actual invention or device (X-Tender) is circled and identified by the name of the invention “X-Tender”. From the drawing, one can visualize the male threaded end which attaches to the mounting eyelet of the suspension mechanism and the female threaded end of the device which connects to shock shaft of the mechanism.

FIG. 4 (four) is a dimensional pictorial view of the device drawn to scale. FIG. 4(1) and 4(4) are milled or planned notches or flats on opposite sides of the body of the device designed to fit a eleventh sixteen (11/16) inch box wrench in order to assist in assembly of the “X-Tender” to the bikes suspension mechanism. FIG. 4(3) is the body of the “X-Tender”. FIG. 4(2) is a drilled and tapped hole 1.000 inch into the body of the “X-Tender” and female thread to 9 mm×1.25 and counter-bored with a diameter of 0.421 inches at a depth of 0.187 inches.

FIG. 4(5) is the male fitting of the “X-Tender” turned an lathe to accept a mm 9×1.125 thread and is 0.5000 inches long from the body of the “X-Tender” to its end.

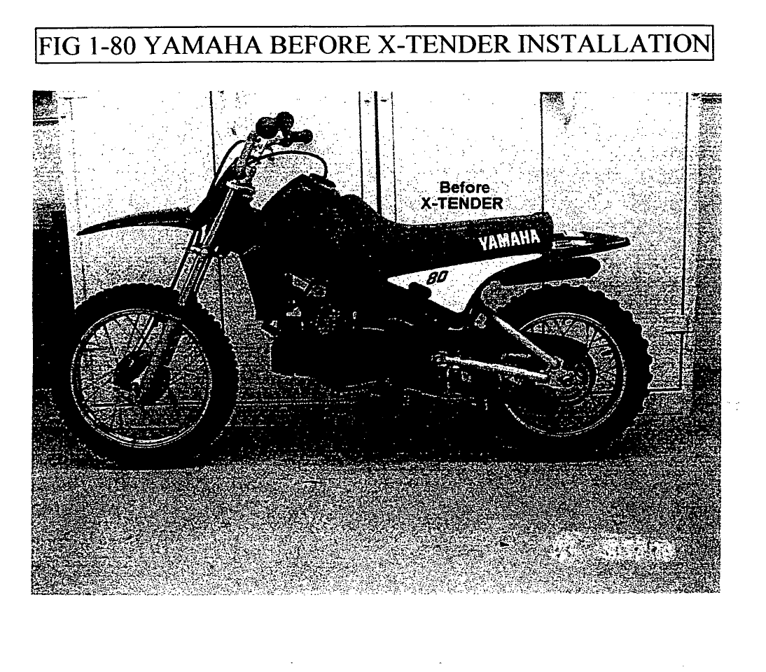

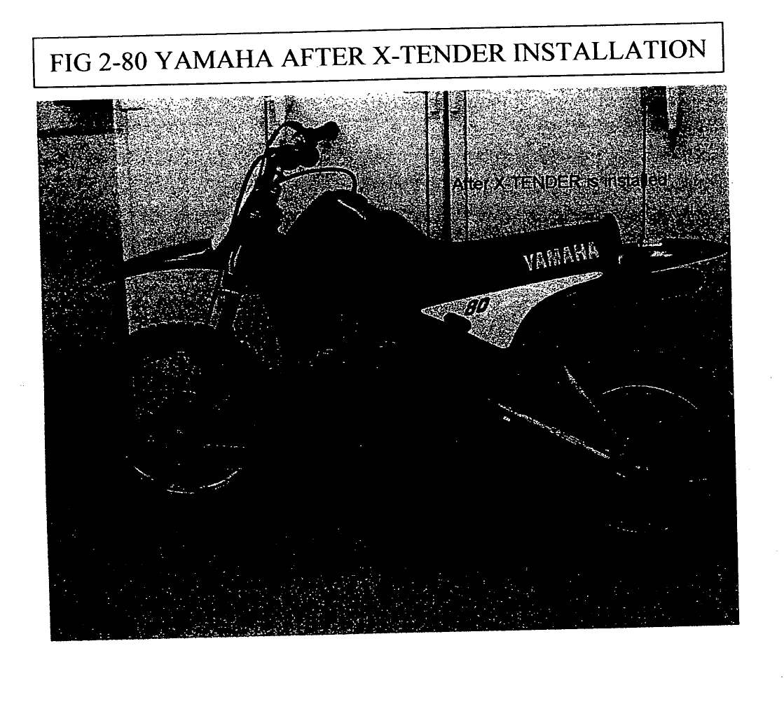

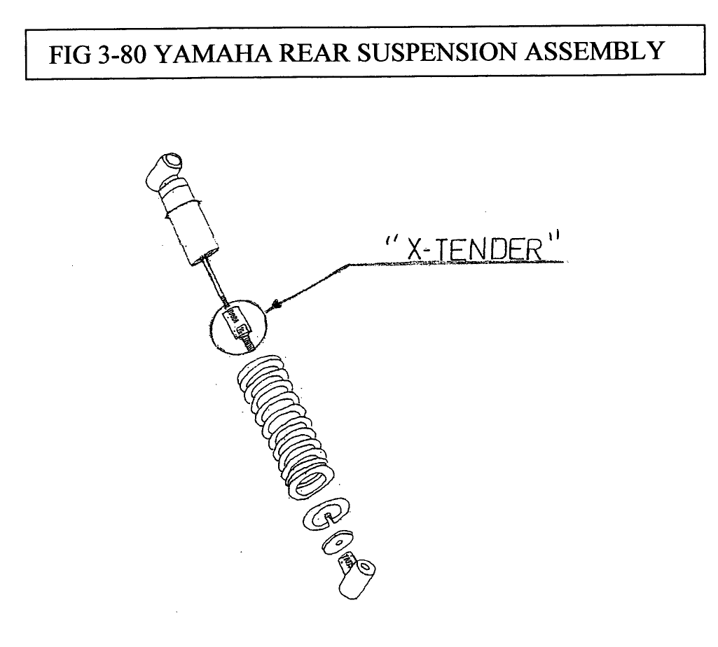

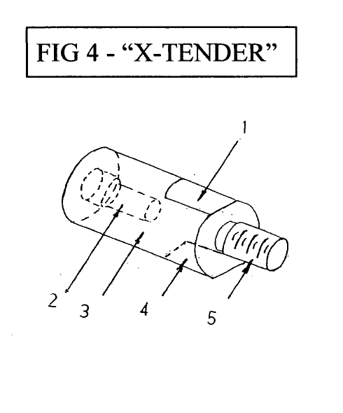

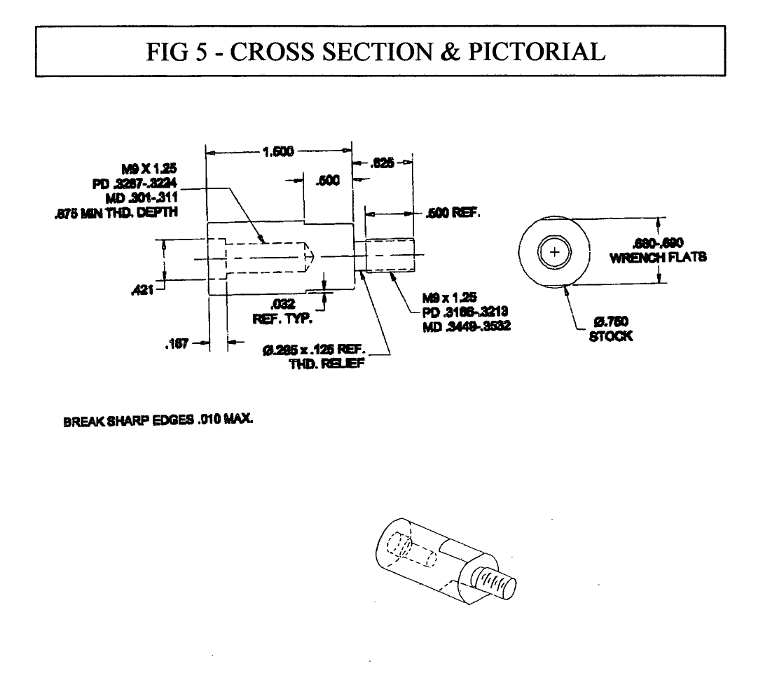

FIG. five (5) is a working mechanical drawing and milling instructions for the “X-Tender” which reveals the following information:
1. Overall Length 2.125
2. Diameter (Width) 0.75 in
3. Thread size:
   A. Male 9 mm×1.28
   B. Female 9 mm×1.28
      The weight of the “X-Tender”, is approximately (0.5) pounds.

### DETAILED DESCRIPTION OF THE INVENTION

The invention is made from one solid piece of round diameter 1215 (CRS) cold rolled steel. The stock is machined down in a lathe and mill to form the finished device and more particular described as follows:

It is cylindrical in shape with the main body or part measuring ¼ inch in diameter. The overall length is 2.125 inches (2⅛). The opposite end is turned (machined) down in diameter on a lathe to except 9 mm×1.125 threads with a length of ½ inch (0.500″). Where the base of the male threaded shaft and the ¾ inh main body meet there are two flat surfaces “on the ¾ inch main body side” milled/machined 180 degrees opposite of one another to except a 11/16 inch.

The opposite end from the male threaded end “3/4 inch main body” has been drilled and tapped to except the 9 mm×1.125 threads on a shock in which the device is intended for. Depth of thread hole is 1.000 inch (1 inch). It has been centerboard at the threaded hole for relief, at a diameter of 0.421 inch and a depth of 0.187 inch (3/16 inch).

1. A steel part or device cut, milled, and turned, threaded at each end and designed to attach to the shock shaft and eyelet on the rear suspension mechanism of a motor bike in order to extend the overall length of the shock and allow maximum travel, and raising the motor bike seat level distance from the ground by approximately four (4) inches.
